(19) United States
(12) Patent Application Publication
(10) Pub. No.: US 2010/0198548 A1
(43) Pub. Date: Aug. 5, 2010

(54) DIAGNOSTIC APPARATUS, DIAGNOSTIC METHOD AND TEST APPARATUS

(75) Inventor: Hiroshi SATO, Gunma (JP)

Correspondence Address: Masao Yoshimura, 333 W. El Camino Real, Suite 380, Sunnyvale, CA, 94087, US

(73) Assignee: ADVANTEST CORPORATION, Tokyo (JP)

(21) Appl. No.: 12/693,120

(22) Filed: Jan. 25, 2010

(30) Foreign Application Priority Data
Jan. 30, 2009 (JP) 2009-020077

(51) Int. Cl. G06F 19/00; G06F 11/30

(52) U.S. Cl. 702/116; 702/183

(57) ABSTRACT

There is provided a diagnostic apparatus for diagnosing a test apparatus including a plurality of test modules designed to test a device under test. The diagnostic apparatus includes a configuration storing section that stores thereon configuration information describing a type and a connection of each of the plurality of test modules, a generating section that generates a pattern file based on the configuration information, where the pattern file describes a diagnostic pattern used to diagnose each of the plurality of test modules, and a diagnosing section that causes each of the plurality of test modules to generate a diagnostic signal in accordance with a corresponding diagnostic pattern in order to diagnose the test module.

### BACKGROUND

1. Technical Field

The present invention relates to a diagnostic apparatus, a diagnostic method and a test apparatus for diagnosing a test module designed to test a device under test.

2. Related Art

A known test apparatus is adapted to test a device under test by using a plurality of test modules (for example, see Patent Document 1). Such test modules are compatible with the input/output interface of the test apparatus and can be freely connected/disconnected to/from the test apparatus. Accordingly, the test apparatus can test the device under test by using many types of test modules. The test apparatus also has a diagnostic capability of diagnosing whether the test modules can correctly operate.

Patent Document 1: Japanese Patent Application Publication No. 2006-317256

Here, the types and number of the test modules mounted onto such a test apparatus may vary depending on the types and number of devices under test that are simultaneously tested. Accordingly, when in the diagnosis mode, the test apparatus sequentially selects the test modules mounted thereon one at a time, identifies the type of the selected test module with reference to a configuration file describing the correspondences between the slots and the test modules, and then diagnoses the selected test module in an appropriate manner.

However, it takes a long time to complete diagnosing all of the test modules if the test modules are sequentially selected and diagnosed one at a time as described above. This drawback becomes serious when a large number of test modules are provided in the test apparatus.

### SUMMARY

Therefore, it is an object of an aspect of the innovations herein to provide a diagnostic apparatus, a diagnostic method, and a test apparatus which are capable of overcoming the above drawbacks accompanying the related art. The above and other objects can be achieved by combinations described in the independent claims. The dependent claims define further advantageous and exemplary combinations of the innovations herein.

According to an aspect related to the innovations herein, one exemplary apparatus may include a diagnostic apparatus for diagnosing a test apparatus including a plurality of test modules designed to test a device under test. The diagnostic apparatus includes a configuration storing section that stores thereon configuration information describing a type and a connection of each of the plurality of test modules, a generating section that generates a pattern file based on the configuration information, where the pattern file describes a diagnostic pattern used to diagnose each of the plurality of test modules, and a diagnosing section that causes each of the plurality of test modules to generate a diagnostic signal in accordance with a corresponding diagnostic pattern in order to diagnose the test module. Also, a diagnostic method and a test apparatus are provided.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 illustrates the configuration of a test apparatus 10 relating to an embodiment of the present invention.

FIG. 2 illustrates the functional configuration of a test module 20.

FIG. 3 illustrates the functional configuration of a diagnostic apparatus 50.

FIG. 4 illustrates, as an example, the periods during which a plurality of test modules 20 are operating when the test apparatus 10 diagnoses the test modules 20.

FIG. 5 illustrates an exemplary configuration of the test apparatus 10.

FIG. 6 schematically illustrates an exemplary configuration of a test head 80 of the test apparatus 10.

FIG. 7 illustrates, as an example, test module information described in configuration information used in the test apparatus 10 having the configuration shown in FIG. 6.

FIG. 8 illustrates exemplary connection described in the configuration information used in the test apparatus 10 having the configuration shown in FIG. 6.

FIG. 9 illustrates an exemplary diagnostic pattern.

FIG. 10 illustrates, as an example, signal names described in a parameter file.

FIG. 11 illustrates an exemplary correspondence between a signal name of a diagnostic signal and a connector pin number of a connector 84 described in the parameter file.

FIG. 12 illustrates an exemplary hardware configuration of a computer 1900 relating to an embodiment of the present invention.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

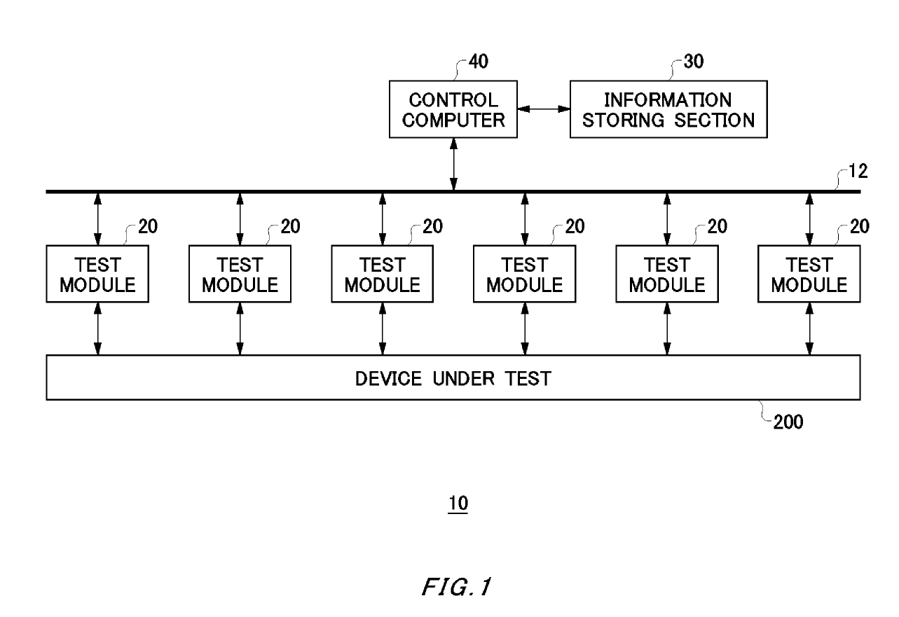

FIG. 1 illustrates the configuration of a test apparatus 10 relating to an embodiment of the present invention. The test apparatus 10 is designed to test a device under test 200 such as a semiconductor circuit. The test apparatus 10 includes buses 12, a plurality of test modules 20, an information storing section 30, and a control computer 40.

Each test module 20 is inserted into a slot provided in the test apparatus 10. Each test module 20 tests the device under test 200 by exchanging signals with the device under test 200. More specifically, each test module 20 has one or more pins that exchange signals, and each pin is electrically connected to any of the terminals of the device under test 200.

The test modules 20 may be of different types. For example, a certain test module 20 has a function of supplying a test signal with a predetermined logic pattern to the device under test 200, and a different test module 20 has a function of supplying an operational clock, a power supply, and the like to the device under test 200. While testing the device under test 200, the test apparatus 10 controls the test modules 20 to operate in parallel. Here, the test apparatus 10 may test a single device under test 200, or may test a plurality of devices under test 200 in parallel.

The information storing section 30 stores thereon configuration information describing the types and connections of the test modules 20 provided in the test apparatus 10. The information storing section 30 also stores thereon programs to be executed by the control computer 40, test patterns, and diagnostic patterns, and the like.

The control computer 40 controls the individual test modules 20 via the buses 12. When the test apparatus 10 tests the device under test 200, the control computer 40 executes a test program to function as a test control apparatus that controls the tests to be performed by the respective test modules 20.

To be more specific, when the test apparatus 10 is in the test mode, the control computer 40 supplies to each test module 20 a test pattern including an instruction sequence and pattern data, and causes each test module 20 to execute the test pattern. In this manner, each test module 20 can test the device under test 200 by supplying a test signal corresponding to the test pattern to a corresponding terminal of the device under test 200.

The test apparatus 10 also has a function of diagnosing whether the individual test modules 20 can correctly operate. When the test apparatus 10 diagnoses the test modules 20, the control computer 40 executes a diagnostic program to function as a diagnostic apparatus that diagnoses the individual test modules 20.

To be more specific, when the test apparatus 10 is in the diagnosis mode, the device under test 200 is removed from the test apparatus 10 and a diagnostic circuit or the like is instead attached to the test apparatus 10. For example, the diagnostic circuit inputs a signal output from any pin of a given test module 20 into any pin of the given test module 20 or a different test module 20.

When the diagnostic circuit is attached to the test apparatus 10, the control computer 40 supplies to each test module 20 a diagnostic pattern including an instruction sequence and pattern data and causes each test module 20 to execute the diagnostic pattern. In this manner, each test module 20 can generate a diagnostic signal in accordance with the diagnostic pattern for each pin of the test module 20 to diagnose itself.

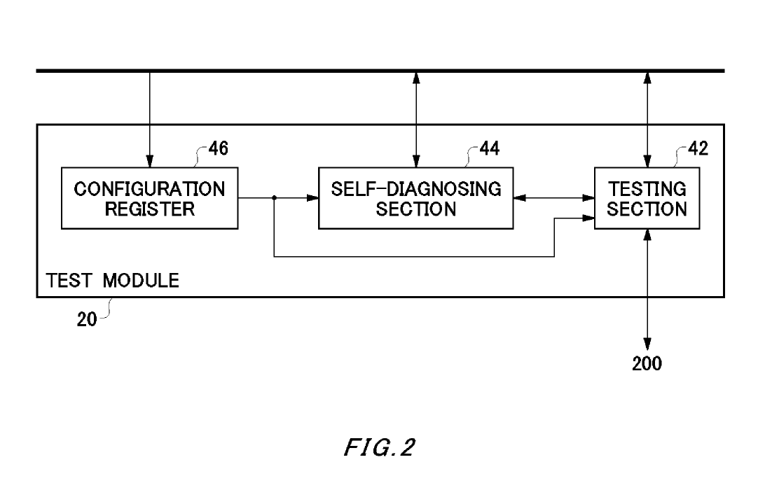

FIG. 2 illustrates the functional configuration of each test module 20. Each test module 20 includes a testing section 42, a self-diagnosing section 44, and a configuration register 46.

The testing section 42 tests the device under test 200 by exchanging signals with a predetermined terminal of the device under test 200. The testing section 42 receives a test pattern via the bus 12 from the control computer 40 when the test apparatus 10 is in the test mode. The testing section 42 executes the received test pattern, generates a test signal in accordance with the test pattern, and supplies the generated test signal to a designated terminal of the device under test 200.

Furthermore, the testing section 42 executes the test pattern, compares an expected value generated in accordance with the test pattern with a response signal output from the device under test 200, and thus judges whether the device under test 200 is acceptable based on the result of the comparison. The testing section 42 then notifies, of the control computer 40 via the bus 12, the result of the judgment as to whether the device under test 200 is acceptable.

The self-diagnosing section 44 executes a diagnostic pattern to diagnose whether the testing section 42 correctly operates. When the test apparatus 10 is in the diagnosis mode, the self-diagnosing section 44 receives a diagnostic pattern via the bus 12 from the control computer 40. The testing section 42 executes the received diagnostic pattern, generates a diagnostic signal in accordance with the diagnostic pattern, and outputs the generated diagnostic signal from a designated pin of the test module 20.

Furthermore, the self-diagnosing section 44 executes the diagnostic pattern, compares a diagnostic expected value generated in accordance with the diagnostic pattern with a signal output from any pin of the test module 20, and thus judges whether the testing section 42 correctly operates. The self-diagnosing section 44 notifies the result of the judgment of the control computer 40 via the bus 12.

The configuration register 46 stores thereon configuration values that are set to the test module 20 via the bus 12 by the control computer 40 when the test apparatus 10 is in both the test mode and the diagnosis mode. For example, the configuration register 46 receives, via the bus 12, configuration values such as the voltage values, current values, or frequencies of the signals to be generated by the test module 20. The testing section 42 and the self-diagnosing section 44 respectively generate a test signal and a diagnostic signal in accordance with the configuration values stored on the configuration registers 46.

According to the present embodiment, the testing section 42 and the self-diagnosing section 44 are implemented by a single piece of hardware. Specifically speaking, when a sequencer of the test module 20 executes a test pattern, the respective hardware components of the test module 20 function as the testing section 42. On the other hand, when the sequencer of the test module 20 executes a diagnostic pattern, the respective hardware components of the test module 20 function as the self-diagnosing section 44.

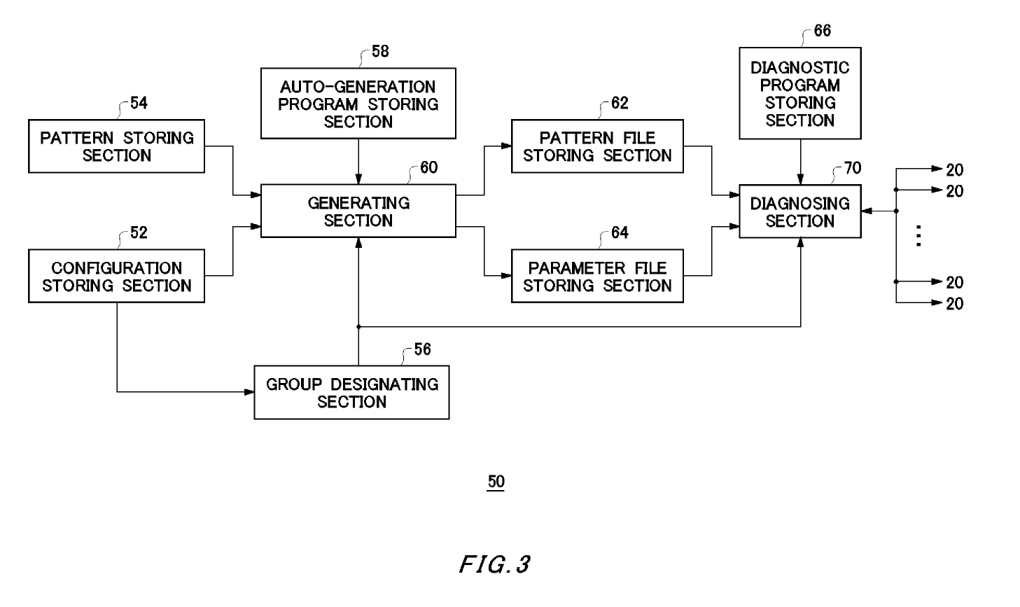

FIG. 3 illustrates the functional configuration of a diagnostic apparatus 50. When the test apparatus 10 is in the diagnosis mode, the control computer 40 and the information storing section 30 together function as the diagnostic apparatus 50 that diagnoses the test apparatus 10 as shown in FIG. 3. The diagnostic apparatus 50 includes a configuration storing section 52, a pattern storing section 54, a group designating section 56, an auto-generation program storing section 58, a generating section 60, a pattern file storing section 62, a parameter file storing section 64, a diagnostic program storing section 66, and a diagnosing section 70.

The configuration storing section 52 stores thereon configuration information describing the types and connections of the test modules 20 included in the test apparatus 10. The configuration information is updated by a user or the like every time one or more test modules are added to the test apparatus 10, one or more test modules are removed from the test apparatus 10, and one or more of the test modules attached to the test apparatus 10 are replaced with different test modules.

For example, the configuration information describes the connection of each test module 20 using the bus number of the bus 12 connecting the test module 20 to the control computer 40 and the slot number of the slot into which the test module 20 is loaded. Furthermore, the configuration information describes the connection of each test module 20 using the pin numbers of the module pins of the test module 20 and the pin numbers of the connector pins of the connector electrically connected to the module pins, for example. Here, each connector pin is electrically connected to a terminal of the device under test 200.

The pattern storing section 54 stores, in association with each type of test modules 20, a diagnostic pattern used to diagnose the test modules 20 of that type. The diagnostic patterns stored on the pattern storing section 54 are generated, for example, by the manufacturers of the test modules 20. The pattern storing section 54 may further store thereon diagnostic patterns for test modules 20 of particular types that will be mounted onto the test apparatus 10 in the future, in addition to the diagnostic patterns for the test modules 20 that are currently mounted onto the test apparatus 10.

The group designating section 56 designates one or more test modules 20 of the same type, from among the test modules 20 provided in the test apparatus 10, as a group of test modules 20 that are diagnosed in parallel. Here, there is a predetermined upper limit for the number of test modules 20 that can be diagnosed in parallel by the diagnostic apparatus 50. When the test apparatus 10 includes test modules 20 of a given type in a larger number than the predetermined upper limit, the group designating section 56 designates a plurality of groups each including test modules 20 of the given type in a number equal to or smaller than the predetermined upper limit.

The auto-generation program storing section 58 stores thereon an auto-generation program used for generating a pattern file and a parameter file. The control computer 40 reads and executes the auto-generation program prior to the diagnosis.

The generating section 60 is implemented when the control computer 40 executes the auto-generation program. The generating section 60 generates a pattern file describing a diagnostic pattern for diagnosing each test module 20, based on the configuration information and the diagnostic patterns stored on the pattern storing section 54. Furthermore, the generating section 60 generates a parameter file based on the configuration information. The parameter file describes, for each test module 20, a correspondence between diagnostic signals generated by the test module 20 and connector pins connected to the device under test 200.

For example, the generating section 60 generates a pattern file and a parameter file in association with each group of test modules 20 designated by the group designating section 56. The generating section 60 stores the generated pattern file onto the pattern file storing section 62. Similarly, the generating section 60 stores the generated parameter file onto the parameter file storing section 64.

The diagnostic program storing section 66 stores thereon a diagnostic program used for diagnosing the test modules 20 provided in the test apparatus 10. When the test apparatus 10 is in the diagnosis mode, the control computer 40 executes the diagnostic program.

The diagnosing section 70 is implemented when the control computer 40 executes the diagnostic program. The diagnosing section 70 causes each test module 20 to generate diagnostic signals in accordance with a corresponding diagnostic pattern, in order to diagnose the test module 20. In this case, the diagnosing section 70 causes each test module 20 to generate the diagnostic signals in such a manner that the diagnostic signals are supplied to corresponding connector pins described in the parameter file.

The diagnosing section 70 executes the diagnostic program for each group of one or more test modules 20 designated by the group designating section 56, to cause all the test modules 20 in the designated group to generate the same set of diagnostic signals. For example, the diagnosing section 70 reads the pattern file from the pattern file storing section 62 and the parameter file from the parameter file storing section 64.

Subsequently, the diagnosing section 70 uses the read pattern file and parameter file to generate a diagnostic pattern for each of the test modules 20 included in the designated group. More specifically, the diagnosing section 70 selects, rearranges and the like the necessary diagnostic patterns from the read pattern file so that the diagnostic signals generated by each test module 20 are supplied to corresponding connector pins described in the parameter file.

Subsequently, the diagnosing section 70 supplies a corresponding diagnostic pattern to each test module 20. The diagnosing section 70 then supplies configuration values to the configuration register 46 of each test module 20. After this, the diagnosing section 70 instructs each test module 20 to start self-diagnosis.

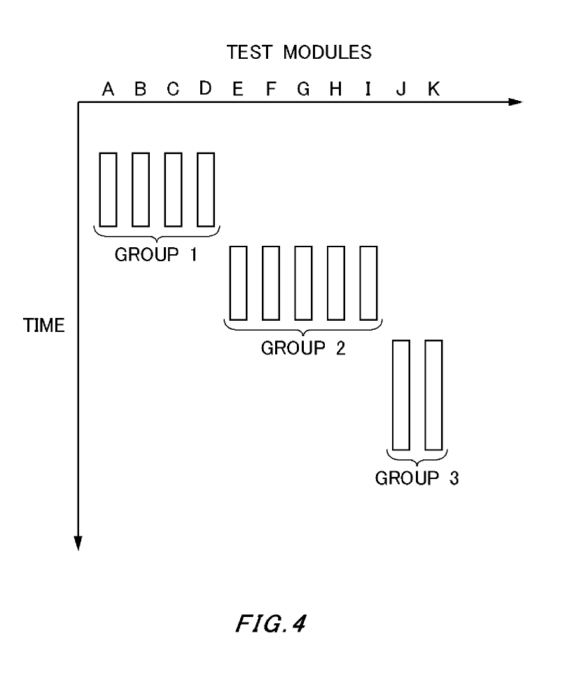

FIG. 4 illustrates, as an example, the periods during which the plurality of test modules 20 are operating when the test modules 20 are diagnosed. Although FIG. 4 shows test modules 20 represented by the alphabetical letters A to K, the number of test modules 20 is not limited to such.

The control computer 40 generates, for test modules 20 that are configured to use the same diagnostic pattern, the diagnostic pattern in parallel, and supplies the generated diagnostic pattern to the test modules 20 so that the test modules 20 executes the diagnostic pattern. For example, the control computer 40 generates, for a plurality of test modules 20 included in each designated group, a diagnostic pattern, and supplies the generated diagnostic pattern to the test modules 20 to cause the test modules 20 to execute the diagnostic pattern.

After supplying the diagnostic pattern to the individual test modules 20, the control computer 40 instructs the test modules 20 to start executing the diagnostic pattern. After the individual test modules 20 complete executing the diagnostic pattern, the control computer 40 obtains diagnoses from the individual test modules 20.

With the above-described configuration, the diagnostic apparatus 50 can shorten the time required to complete diagnosing all the test modules 20 by diagnosing two or more test modules 20 in parallel. Furthermore, since the diagnostic apparatus 50 automatically generates the pattern files and the parameter files based on the configuration information, the user of the test apparatus 10 can be saved from the burden of generating the pattern files and the parameter files every time changes are made in the configurations of the test modules 20 provided in the test apparatus 10. In addition, the diagnostic apparatus 50 having the above-described configuration can save the user from the burden of recompiling the diagnostic program every time changes are made in the types and connections of the test modules 20 in the test apparatus 10.

The generating section 60 may rewrite the diagnostic program stored on the diagnostic program storing section 66 in response to changes made in the configuration information. For example, the generating section 60 may rewrite the configuration values that are described in the diagnostic program and to be written into the configuration registers 46 in order to rewrite the configuration values of the diagnostic signals to be generated by the test modules 20 such as the voltage values, current values and frequencies. In this case, the generating section 60 recompiles the rewritten diagnostic program. Thus, the diagnostic apparatus 50 can save the user from a burden of manipulation.

The generating section 60 also recompiles the diagnostic program when the diagnostic program is rewritten for other purposes. For example, the generating section 60 recompiles the rewritten diagnostic program when the diagnostic program that is originally designed to diagnose one type of test modules 20 is rewritten so as to diagnose a plurality of types of test modules 20, or when the diagnostic program is rewritten by referring to the parameter file and with the knowledge of the types of the test modules 20 to be diagnosed.

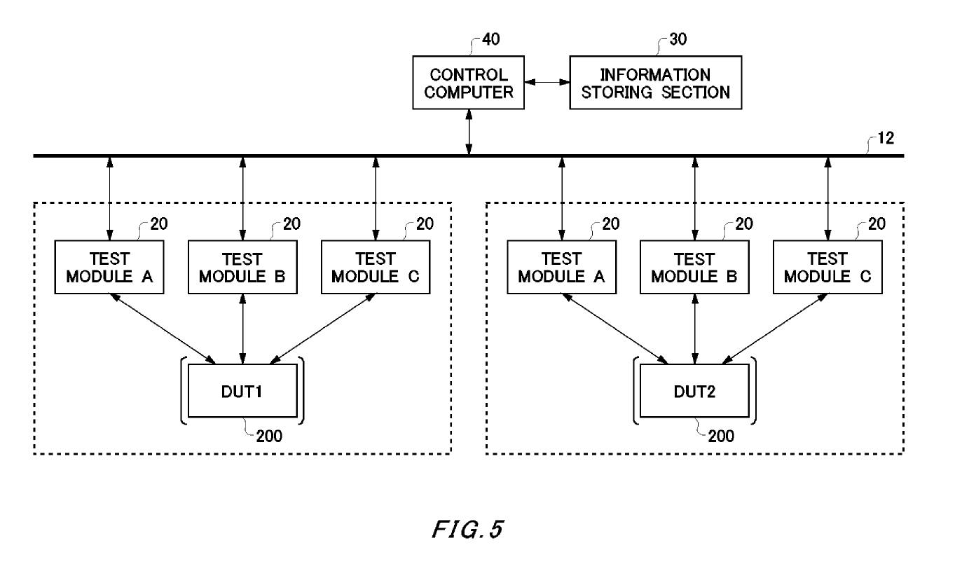

FIG. 5 illustrates an exemplary configuration of the test apparatus 10. The test apparatus 10 may be configured in such a manner that a plurality of test modules 20 are connected to one device under test (DUT) 200. For example, the test apparatus 10 may be configured in such a manner that a plurality of types of test modules 20 (in the example shown in FIG. 5, three types of test modules 200 A, B and C) are connected to one device under test 200.

Furthermore, the test apparatus 10 may be configured to test a plurality of devices under test 200 in parallel. Stated differently, the test apparatus 10 may be configured in such a manner that a plurality of types of devices under test 200 are connected to each of a plurality of devices under test 200. In this case, the control computer 40 executes a test program that is designed to cause a plurality of types of test modules 20 to operate in parallel when the test apparatus 10 is in the test mode.

When configured in the above-described manner, the test apparatus 10 diagnoses the test modules 20 in such a manner that the diagnostic apparatus 50 sequentially generates and supplies diagnostic patterns associated with the respective types of test modules 20. The diagnostic apparatus 50 then simultaneously instructs the plurality of types of test modules 20 to start executing their corresponding diagnostic patterns, to cause the plurality of types of test modules 20 to operate in parallel. In this manner, the diagnostic apparatus 50 can easily diagnose a plurality of types of test modules 20 by causing the test modules to operate in parallel without changing the test-mode environment of the test apparatus 10.

Alternatively, the test apparatus 10 may be configured to include a plurality of control computers 40. In this case, each control computer 40 can implement one diagnostic apparatus 50. When configured in this way, the test apparatus 10 can diagnose more test modules 20 in parallel and speed up the operations of the diagnostic apparatuses 50, when compared with a case where the test apparatus 10 includes only one control computer 40.

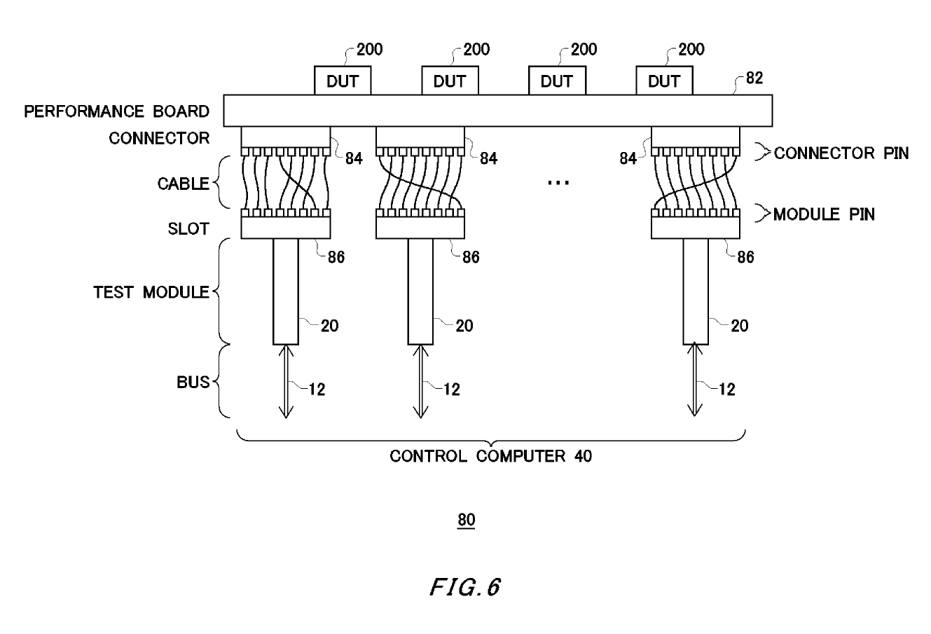

FIG. 6 schematically illustrates an exemplary configuration of a test head 80 of the test apparatus 10. The test apparatus 10 includes the test head 80.

To the test head 80, a performance board 82 is attached. On the performance board 82, the devices under test 200 are mounted when the test apparatus 10 is in the test mode.

The performance board 82 has at least one connector 84 provided on a surface thereof opposite to the surface on which, for example, the devices under test 200 are mounted. Each connector 84 has a plurality of connector pins. Each connector pin is electrically connected to a given terminal of a device under test 200 via the wirings formed in the performance board 82.

The test head 80 also includes a plurality of slots 86 into which the test modules 20 are inserted. Each slot 86 has a plurality of module pins each of which is connected to a given pin of the test module 20 inserted into the slot 86.

In the above-described test head 80, the module pins of the slots into which the test modules 20 are inserted are electrically connected via cables to the connector pins of the connectors 84. In this manner, the test modules 20 can test the devices under test 200 by exchanging signals with the devices under test 200.

The individual test modules 20 in the test head 80 are connected to the control computer 40 via the buses 12 represented by different bus numbers. The control computer 40 can control a designated test module 20 by accesses the test module 20 through designation of a corresponding bus number.

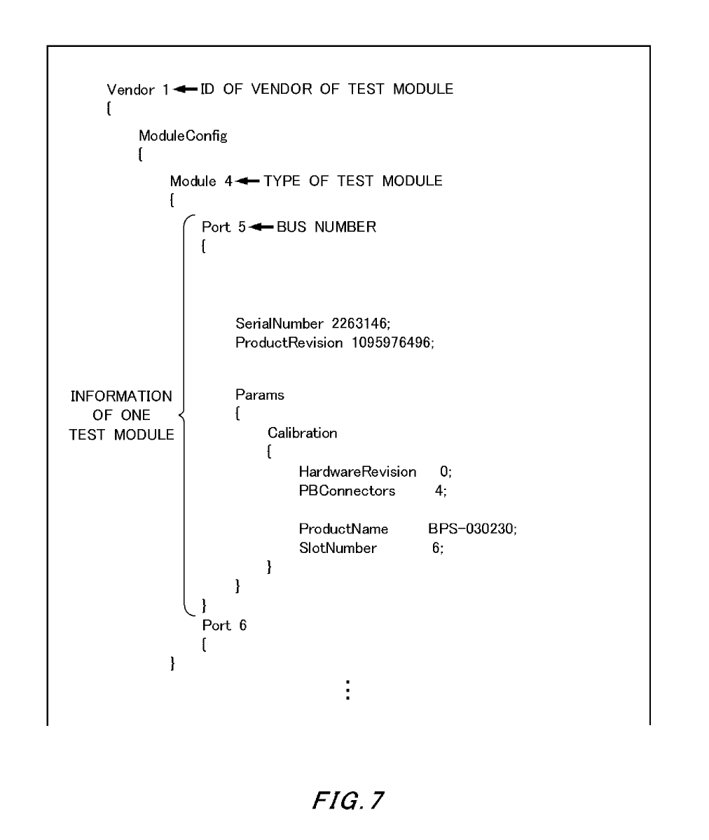

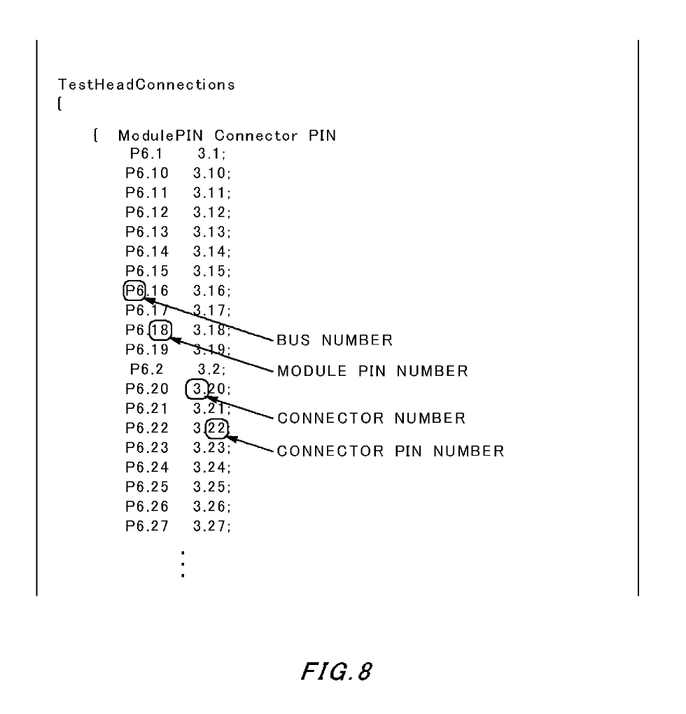

FIGS. 7 and 8 illustrate, as an example, the configuration information used in the test apparatus 10 having the configuration shown in FIG. 6. The configuration information describes test module information in association with each of the test modules 20 mounted onto the test apparatus 10.

As shown in FIG. 7, the configuration information describes the ID of the vendor that has manufactured each test module 20, the type of the test module 20, and test module information classified according to the bus number of the bus 12 connected to the test module 20, for example. The test module information describes the serial number of the test module 20, the version number of the test module 20, the version number of the hardware, the connector number of the connector 84 connected to the test module 20, the name of the test module 20, and the slot number of the slot 86 into which the test module 20 is inserted.

The control computer 40 refers to the above-described configuration information to determine the type of the test module 20 connected to the bus 12 represented by each bus number. The control computer 40 also refers to the configuration information to determine the slot number of the slot 86 to which the test module 20 is connected, and the connector number of the connector 84 to which the test module 20 is electrically connected.

As shown in FIG. 8, the configuration information also describes the correspondences between the module pin numbers of the slots 86 and the connector numbers of the connectors 84. More specifically, the configuration information describes the correspondences between (i) the values (ModulePin) defined by the combination of the bus number and the module pin number and (ii) the values (ConnectorPin) defined by the combination of the connector number and the connector pin number. The control computer 40 refers to the configuration information to determine the manner in which the pins of the test modules 20 are connected to the terminals of the devices under test 200.

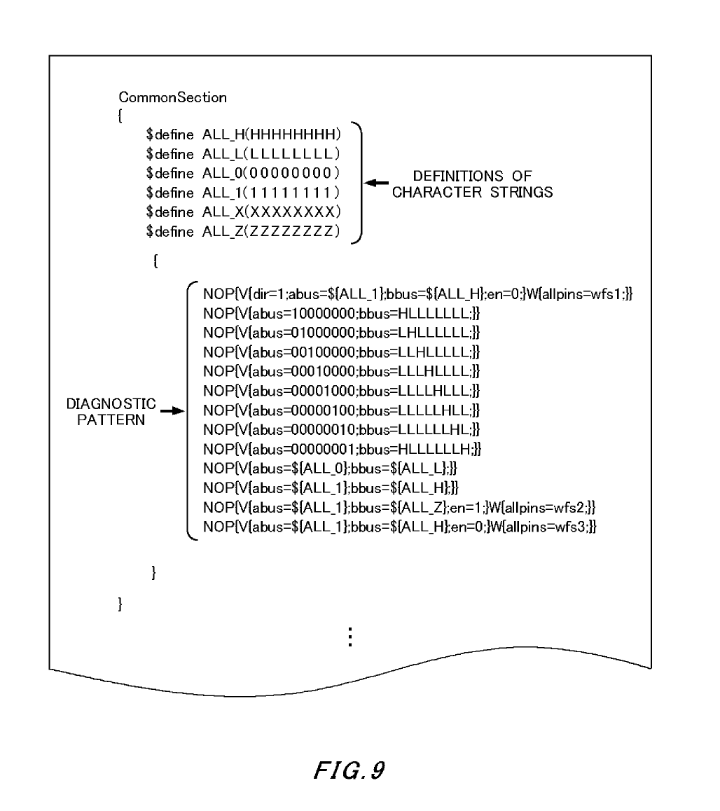

FIG. 9 illustrates an example of the diagnostic pattern stored on the pattern file storing section 62. The diagnostic pattern describes an instruction sequence including a plurality of instructions that are sequentially executed. For example, the instruction sequence includes instructions such as a NOP instruction to proceed to the next instruction, a JAMP instruction to return to an instruction at a predetermined location, and an EXIT instruction to end the execution of instructions.

The diagnostic pattern also describes pattern data in association with each of the instructions in the instruction sequence. The pattern data includes the signal name of a diagnostic signal to be generated, the logic value of the diagnostic signal to be generated, and the frequency of the diagnostic signal to be generated.

In the exemplary diagnostic pattern shown in FIG. 9, the characters and numbers within the curly brackets { } following the character V designate the signal name and logic value of the diagnostic signal to be generated, and the characters and numbers within the curly brackets { } following the character W designate the frequency of the diagnostic signal to be generated. For an instruction for which no frequency is designated, the frequency designated to the previous instruction is used.

In the exemplary diagnostic pattern shown in FIG. 9, the character strings “abus,” “bbus,” “dir,” and “en” each represent the signal name of a diagnostic signal. The character strings “abus” and “bbus” each represent a diagnostic signal having eight bits, each of which is associated with any one of the terminals of a device under test 200. The character strings “dir” and “en” each represent a diagnostic signal having one bit, which is associated with a terminal of a device under test 200.

What follows the signal name of the diagnostic signal represents the logic values to be generated. The logic values include, for example, 1, 0, H, L, X (not determined) and the like. Each test module 20 executes the above-described diagnostic pattern, to generate diagnostic signals and output the diagnostic signals from designated pins of the test module 20.

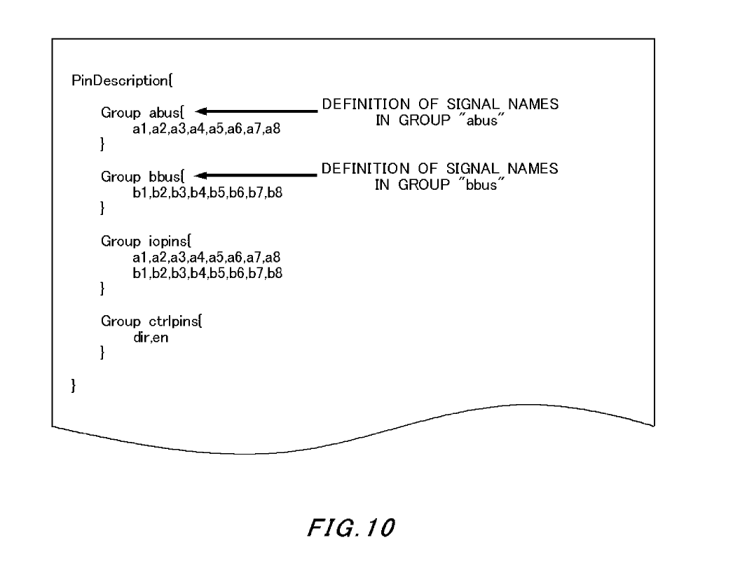

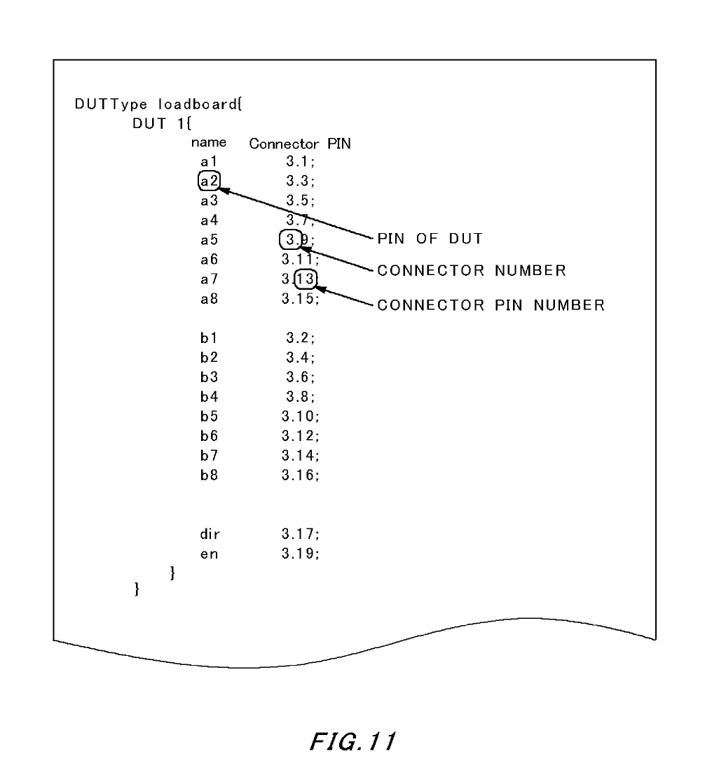

FIGS. 10 and 11 illustrate an example of the parameter file stored on the parameter file storing section 64. As shown in FIG. 10, the parameter file describes the signal name of each of the bits of the diagnostic signal described in the test pattern.

For example, the parameter file describes the signal names of the individual bits of the 8-bit signal named “abus” as “a8,” “a7,” “a6,” “a5,” “a4,” “a3,” “a2,” and “a1” in the descending order from the first bit. Also, the parameter file describes the signal names of the individual bits of the 8-bit signal named “bbus” as “b8,” “b7,” “b6,” “b5,” “b4,” “b3,” “b2,” and “b1” in the descending order from the first bit.

Here, the individual 1-bit signals are associated with the terminals of the device under test 200. For example, when the diagnostic pattern has a description of abus=“10000000,” a value “1” is output to the terminal associated with the signal a1.

As shown in FIG. 11, the parameter file also describes the correspondences between the signal names of the diagnostic signals generated by the test modules 20 provided in the test apparatus 10 and the connector pin numbers of the connectors 84 that supply the diagnostic signals. For example, the parameter file describes the correspondences between the signal names of the 1-bit signals and the values (ConnectorPin) defined by the combination of the connector number and the connector pin number.

The diagnosing section 70 refers to the above-described parameter file to rewrite the diagnostic pattern associated with each test module 20 and supplies the rewritten diagnostic pattern to the test module 20. Specifically speaking, the diagnosing section 70 rewrites the diagnostic pattern associated with each test module 20 with reference to the parameter file so that the diagnostic signals generated the test module 20 are supplied to the corresponding connector pins whose pin numbers are associated with the signal names of the generated diagnostic signals in the parameter file, and then supplies the rewritten diagnostic pattern to the test module 20.

Stated differently, the diagnosing section 70 rewrites the diagnostic pattern such that the test modules 20 generate and output the diagnostic signals in accordance with the correspondences between the signal names and the connector pin numbers described in the parameter file. In this manner, the diagnosing section 70 can cause the individual test modules 20 to generate appropriate diagnostic signals.

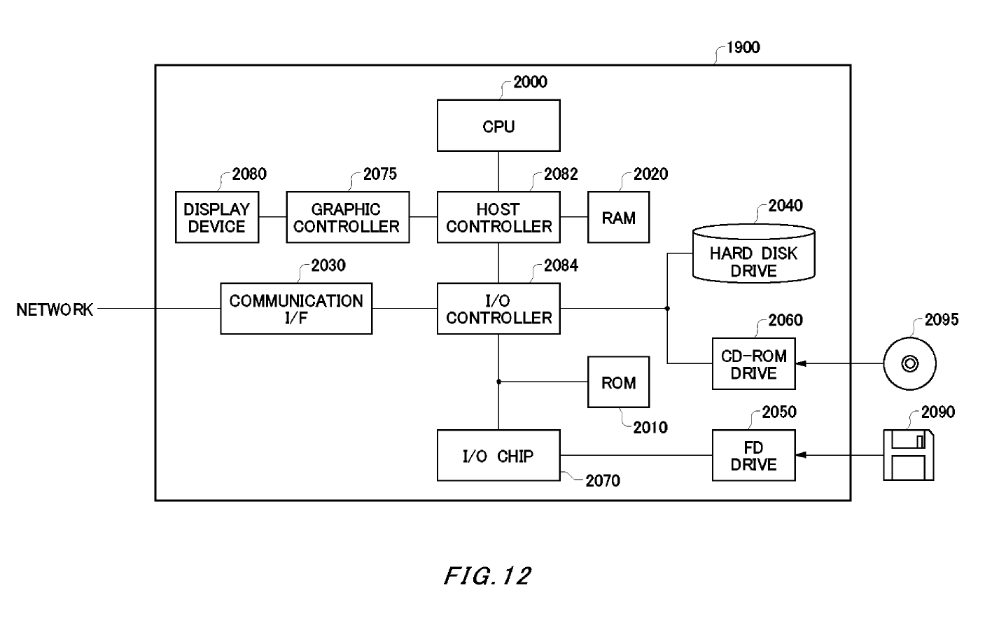

FIG. 12 illustrates an exemplary hardware configuration of a computer 1900 relating to an embodiment of the present invention. The computer 1900 relating to the present embodiment is constituted by a CPU surrounding section, an input/output (I/O) section and a legacy I/O section. The CPU surrounding section includes a CPU 2000, a RAM 2020, a graphic controller 2075 and a display device 2080 which are connected to each other by means of a host controller 2082. The I/O section includes a communication interface 2030, a hard disk drive 2040, and a CD-ROM drive 2060 which are connected to the host controller 2082 by means of an I/O controller 2084. The legacy I/O section includes a ROM 2010, a flexible disk drive 2050, and an I/O chip 2070 which are connected to the I/O controller 2084.

The host controller 2082 connects the RAM 2020 with the CPU 2000 and graphic controller 2075 which access the RAM 2020 at a high transfer rate. The CPU 2000 operates in accordance with programs stored on the ROM 2010 and RAM 2020, to control the constituents. The graphic controller 2075 obtains image data which is generated by the CPU 2000 or the like on a frame buffer provided within the RAM 2020, and causes the display device 2080 to display the obtained image data. Alternatively, the graphic controller 2075 may include therein a frame buffer for storing thereon the image data generated by the CPU 2000 or the like.

The I/O controller 2084 connects, to the host controller 2082, the hard disk drive 2040, communication interface 2030 and CD-ROM drive 2060 which are I/O devices operating at a relatively high rate. The communication interface 2030 communicates with external apparatuses via the network. The hard disk drive 2040 stores thereon programs and data to be used by the CPU 2000 in the computer 1900. The CD-ROM drive 2060 reads programs or data from a CD-ROM 2095, and supplies the read programs or data to the hard disk drive 2040 via the RAM 2020.

The I/O controller 2084 is also connected to the ROM 2010, flexible disk drive 2050 and I/O chip 2070 which are I/O devices operating at a relatively low rate. The ROM 2010 stores thereon a boot program executed by the computer 1900 at the startup, and/or programs dependent on the hardware of the computer 1900. The flexible disk drive 2050 reads programs or data from a flexible disk 2090, and supplies the read programs or data to the hard disk drive 2040 via the RAM 2020. The I/O chip 2070 connects the flexible disk drive 2050 to the I/O controller 2084, and connects a variety of I/O devices to the I/O controller 2084 via, for example, a parallel port, a serial port, a keyboard port, a mouse port or the like.

The programs to be provided to the hard disk drive 2040 via the RAM 2020 are provided by a user in the state of being stored on a recording medium such as the flexible disk 2090, the CD-ROM 2095, or an IC card. The programs are read from the recording medium, installed in the hard disk drive 2040 in the computer 1900 via the RAM 2020, and executed by the CPU 2000.

The programs installed in the computer 1900 and causes the computer 1900 to function as the diagnostic apparatus 50 includes a configuration storing module, a pattern storing module, a group designating module, an auto-generation program storing module, a generating module, a pattern file storing module, a parameter file storing module, a diagnostic programs to ring module, and a diagnosing module. These programs or modules are executed by the CPU 2000 and the like to cause the computer 1900 to function as the configuration storing section 52, the pattern storing section 54, the group designating section 56, the auto-generation program storing section 58, the generating section 60, the pattern file storing section 62, the parameter file storing section 64, the diagnostic program storing section 66, and the diagnosing section 70.

When read by the computer 1900, the information processing described in the programs function as the following concrete means, which are realized by the cooperation between the software and the above-described various hardware resources, such as the configuration storing section 52, the pattern storing section 54, the group designating section 56, the auto-generation program storing section 58, the generating section 60, the pattern file storing section 62, the parameter file storing section 64, the diagnostic program storing section 66, and the diagnosing section 70. These concrete means realize arithmetic and logical operations on or modifications of information in accordance with the purposes of the computer 1900 relating to the present embodiment, thereby constituting the diagnostic apparatus 50 designed to perform particular purposes.

For example, when the computer 1900 communicates with an external apparatus, the CPU 2000 executes the communication program loaded onto the RAM 2020, and instructs the communication interface 2030 to perform communication in accordance with the description in the communication program. Under the control of the CPU 2000, the communication interface 2030 reads transmission data stored in a transmission buffer region provided in a storage such as the RAM 2020, the hard disk drive 2040, the flexible disk 2090, or the CD-ROM 2095 and transmits the transmission data onto a network, or receives reception data from a network and writes the reception data into a reception buffer region provided in a storage. In the above manner, the communication interface 2030 may exchange the transmission data and the reception data with the storage in the direct memory access (DMA) scheme. Alternatively, the transmission data and the reception data may be exchanged in such a manner that the CPU 2000 may read the data from a source that is one of the storage and the communication interface 2030 and writes the data into a destination that is the other of the storage and the communication interface 2030.

The CPU 2000 transfers, by means of the DMA transfer or the like, all or necessary portions of the files or databases stored on an external storage such as the hard disk drive 2040, the CD-ROM drive 2060 (CD-ROM 2095), or the flexible disk drive 2050 (the flexible disk 2090) to the RAM 2020, and processes the data stored on the RAM 2020 in a variety of manners. The CPU 2000 then writes the resultant data back to the external storage by means of the DMA transfer or the like. During this process, the RAM 2020 is considered to temporarily maintain the contents of the external storage. Therefore, in the present embodiment, the RAM 2020 and the external storage are collectively refereed to by a term such as a memory, a storing section, or a storage. In the present embodiment, diverse information such as a variety of programs, data, tables, and databases are stored on such a storage and subjected to information processing. Here, the CPU 2000 may store part of the contents of the RAM 2020 onto a cache memory, to write/read data into/from the cache memory. If such is the case, the cache memory assumes part of the function of the RAM 2020. Therefore, the cache memory is included in the RAM 2020, memory, and/or storage apparatus in the present embodiment, unless otherwise specified.

The CPU 2000 subjects the data read from the RAM 2020 to a variety of processes including diverse arithmetic and logic operations, information modifications, conditional judgments, information retrieval/replacement, which are designated by instruction sequences of programs and disclosed in the present embodiment, and writes the resultant read back to the RAM 2020. For example, in the case of conditional judgments, the CPU 2000 compares a variety of variables relating to the present embodiment with different variables or constants to judge whether the variety of variables relating to the present embodiment satisfy certain conditions, for example, whether they are larger, smaller, no less than, no more than, or equal to the different variables or constants. When the conditions are satisfied (or not satisfied), the CPU 2000 branches into a different instruction sequence or calls a subroutine.

The CPU 2000 can search the information stored on the files or databases within the storage. For example, when the storage stores thereon a plurality of entries in each of which a value of a first attribute is associated with a value of a second attribute, the CPU 2000 searches the plurality of entries stored on the storage for an entry whose value of the first attribute matches a designated condition and then reads the value of the second attribute stored in this entry. In this manner, the CPU 2000 can obtain a value of the second attribute associated with a value of the first attribute that satisfies a predetermined condition.

The programs or modules mentioned above may be stored on an external recording medium. Such a recording medium is, for example, an optical recording medium such as DVD and CD, a magnet-optical recording medium such as MO, a tape medium, a semiconductor memory such as an IC card and the like, in addition to the flexible disk 2090 and CD-ROM 2095. Alternatively, the recording medium may be a storage device such as a hard disk or RAM which is provided in a server system connected to a dedicated communication network or the Internet, and the programs may be provided to the computer 1900 via the network.

Although some aspects of the present invention have been described by way of exemplary embodiments, it should be understood that those skilled in the art might make many changes and substitutions without departing from the spirit and the scope of the present invention which is defined only by the appended claims.

The claims, specification and drawings describe the processes of an apparatus, a system, a program and a method by using the terms such as operations, procedures, steps and stages. When a reference is made to the execution order of the processes, wording such as “before” or “prior to” is not explicitly used. The processes may be performed in any order unless an output of a particular process is used by the following process. In the claims, specification and drawings, a flow of operations may be explained by using the terms such as “first” and “next” for the sake of convenience. This, however, does not necessarily indicate that the operations should be performed in the explained order.

What is claimed is:

1. A diagnostic apparatus for diagnosing a test apparatus including a plurality of test modules designed to test a device under test, the diagnostic apparatus comprising:
a configuration storing section that stores thereon configuration information describing a type and a connection of each of the plurality of test modules;
a generating section that generates a pattern file based on the configuration information, the pattern file describing a diagnostic pattern used to diagnose each of the plurality of test modules; and
a diagnosing section that causes each of the plurality of test modules to generate a diagnostic signal in accordance with a corresponding diagnostic pattern in order to diagnose the test module.

2. The diagnostic apparatus as set forth in claim 1, wherein
the generating section uses the configuration information to generate a parameter file describing, for each of the plurality of test modules, a correspondence between a diagnostic signal to be generated by the test module and a connector pin connected to the device under test, and
the diagnosing section causes each of the plurality of test modules to generate the diagnostic signal so that the diagnostic signal is supplied to a corresponding connector pin described in the parameter file.

3. The diagnostic apparatus as set forth in claim 2, further comprising
a group designating section that designates one or more test modules of a same type as a group, wherein
the diagnosing section causes one or more test modules included in each group designated by the group designating section to generate a same diagnostic signal.

4. The diagnostic apparatus as set forth in claim 3, wherein
when the test apparatus includes test modules of a same type in a number larger than a predetermined number, the group designating section designates a plurality of groups each of which contains one or more test modules of the same type in a number equal to or smaller than the predetermined number.

5. The diagnostic apparatus as set forth in claim 4, wherein
the diagnosing section is implemented by a control computer executing a diagnostic program, and
when the diagnostic program is rewritten, the generating section recompiles the rewritten diagnostic program.

6. The diagnostic apparatus as set forth in claim 5, wherein
when a configuration value that is described in the diagnostic program and to be written into a configuration register of each of the plurality of test modules is rewritten, the generating section recompiles the rewritten diagnostic program.

7. The diagnostic apparatus as set forth in claim 2, wherein
the generating section generates (i) the pattern file describing, for each of the plurality of test modules, the diagnostic pattern designating a signal name and a logic value of the diagnostic signal to be generated by the test module and (ii) the parameter file describing, for each of the plurality of test modules, a correspondence between a signal name of the diagnostic signal to be generated by the test module and a pin number of the connector pin to which the generated diagnostic signal is supplied, and
the diagnosing section rewrites the diagnostic pattern associated with each of the plurality of test modules based on the parameter file such that the diagnostic signal generated by the test module is supplied to a connector pin having a pin number corresponding to a signal name of the generated diagnostic signal, and supplies the rewritten diagnostic pattern to the test module.

8. A diagnostic method for diagnosing a test apparatus including a plurality of test modules designed to test a device under test, the diagnostic method comprising:
generating a pattern file based on configuration information, the pattern file describing a diagnostic pattern used to diagnose each of the plurality of test modules, the configuration information describing a type and a connection of each of the plurality of test modules; and
causing each of the plurality of test modules to generate a diagnostic signal in accordance with a corresponding diagnostic pattern in order to diagnose the test module.

9. A test apparatus for testing a device under test, comprising:
a plurality of test modules that test the device under test; and
the diagnostic apparatus as set forth in claim 1 that diagnoses the plurality of test modules.
